(19) United States
(12) Patent Application Publication
(10) Pub. No.: US 2010/0328743 A1
(43) Pub. Date: Dec. 30, 2010

(54) OPTICAL SYSTEM

(76) Inventors: Edwin Maria Wolterink, Valkenswaard (NL); Richard Gerhardus Johannes Van Densen, Utrecht (NL); Koen Gerard Demeyer, Genk (BE)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/747,446

(22) PCT Filed: Dec. 19, 2008
(86) PCT No.: PCT/NL08/00284

§ 371 Date: Sep. 3, 2010

(30) Foreign Application Priority Data
Dec. 21, 2007 (NL) 1034857

(51) Int. Cl. G02B 5/18; G02B 3/00; B05D 5/06; G02B 5/32; G02B 27/10; G02B 5/30; G06K 7/10

(52) U.S. Cl. 359/19; 359/566; 359/642; 427/163.1; 359/15; 359/619; 359/483; 359/350; 359/352

(57) ABSTRACT

An optical system comprising a substrate and disposed on said substrate a replica layer, characterised in that a functionality selected from the group consisting of grating, volume Bragg grating, holographic, diffractive, non-periodic structure, optical polarizer, micro lens and gradient index lens is incorporated in the substrate. The object of the present invention is therefore to provide an optical system in which elements which previously played a passive part are given an active role in order to thus realise desired properties of the optical system.

The present invention relates to an optical system, comprising a substrate and disposed on said substrate a replica layer. The present invention further relates to a method for manufacturing such an optical system, and also to the use of said optical system. The present invention further relates to a stack of lenses.

The optical systems referred to in the introduction are known per se from International application WO 2004/027880 in the name of the present applicant. From said application there is known an optical system comprising a so-called imaging capturing element or image sensor of the CCD or CMOS type, on which a lens element is disposed, which lens element is separated from the imaging capturing element by means of a spacer, said components being durably joined by means of an adhesive layer. The lens element that is used can be regarded as a lens substrate, on which a lens is separately provided. The lens substrate functions as a carrier or support for the lens. Similar optical systems are known from International application WO 2005/096741, which discloses a lens provided with a volume holographic grating. In addition to that, U.S. patent application US 2005/0.046.947 discloses a diffractive optical element comprising a monolayer or multilayer member composed of a plurality of layers, which are each made of an optical material. Volume holographic optical elements are also known from U.S. patent application US 2002/0.045.104 and U.S. patent application US 2005/0.244.102.

The aforesaid lens systems are in principle based on a substrate on which a lens is separately provided, which substrate does not play an active part as regards the optical functionality thereof but only has a support function.

From US 2004/0.012.698 there is known an optical system in which a functionality is incorporated, but an air layer is present in each of the optical elements used therein, which air layer leads to refractive index transitions for the optical path through the optical system.

Accordingly it is the object of the present invention to provide an optical system in which elements which previously played a passive part are given an active role in order to thus realise desired properties of the optical system.

Another object of the present invention is to provide optical systems in which a high degree of freedom of design is realised by using active substrates, in particular in combination with other passive optical elements.

Yet another object of the present invention is to provide optical systems in which a number of optical functions are combined in a particular element or part for the purpose of thus achieving miniaturisation of the optical system.

The present invention as referred to in the introduction is characterised in that a functionality selected from the group consisting of grating, volume Bragg grating, holographic, diffractive, non-periodic structure, optical filter, polarizer, micro lens and gradient index lens is incorporated in the substrate.

By incorporating a particular functionality in the substrate, an active substrate is obtained, by means the present optical system, depending on the desired properties, can be controlled. It should be noted that the term “incorporate” is understood to mean the implementation or inclusion of a functionality in the substrate, in which connection also the interface between the substrate and the replica layer may be meant in a specific embodiment.

It is possible in the optical system according to the present invention to assign the lens function to the substrate or to the replica layer.

From the viewpoint of availability and processability it is preferable if the substrate is composed of glass or a related optical, transparent inorganic material. Such a substrate is to be regarded as rigid, non-flexible, and consequently it is suitable for use as a carrier in the replication method.

The replica layer used in the present optical system is preferably composed of a UV curable polymer, selected from the group of polycarbonates, polystyrenes, poly(meth)acrylates, polyurethanes, polyamids, polyimids, polyethers, polyepoxides and polyesters. Suitable replication technologies are disclosed in U.S. Pat. Nos. 6,773,638 and 4,890,905, which may be considered to be fully incorporated herein. A replica layer is obtained by using a replication method in which use is made of a mould having a precisely defined surface, for example an aspherical surface, wherein a small amount of a radiation-curable resin, for example a UV curable resin, is applied to the mould surface. Subsequently, the resin is spread over the mould surface, so that the cavities present in the mould are filled with the resin, whereupon the whole is subsequently irradiated for curing the resin and the thus cured product is removed from the mould. The cured product is a negative of the mould surface. An advantage of the replication process is that lenses having an intricate refractive surface, such as an aspherical surface, can be produced in simple manner, without complicated processes of grinding and polishing the lens body being required. In addition to that, the replica layer is durably joined to the surface to which the replica layer is applied, without adhesives being used. In addition, there is no occurrence of so-called “air gaps”, which lead to large refractive index transitions between the surface and the air layer that is present.

In a special embodiment, the optical system according to the present invention is built up of, in succession, an optically active or non-active element, a substrate and a polymeric replica layer, wherein the optically active element has been selected from the group of light sources, such as VCSEL, laser diode, LED, RCLED, OLED and image sensors, for example of the CCD/CMOS type.

To obtain particular optical properties of the present optical system, it is desirable that a coating selected from the group consisting of anti-reflection and infrared reflection, or a combination thereof, be disposed between the polymeric replica layer and the substrate. Moreover, the polymeric replica layer itself may additionally have a refractive, a diffractive or a combined structure.

The present inventors have obtained advantageous results in particular in those cases in which the functionality is of the volume Bragg grating type. For camera use, in particular the functionality of the gradient index lens type is preferred. It has been found that by using the present optical system, control of collimation and distribution of the light before and after the volume Bragg grating element can be realised in an efficient manner. When an optical system of the volume Bragg grating type is used with a laser diode, it is possible to realise a narrowing and stabilisation of the wavelength distribution from a range of, for example, 6 nm to, for example, 1 nm. The present optical system, in which a functionality of the volume Bragg grating type is incorporated, is to be used in particular in situations in which selectivity and control of the wavelength and the associated bandwidth, which is in particular as narrow as possible, are important. Such uses include in particular the transmission, distribution, separation and combination of light signals, especially as a wavelength filter in Wave Division Multiplexing Demultiplexing technologies. Similar optical systems can be used in the efficient pumping of solid-state lasers, which requires a well-defined wavelength with a view to realising a longer life by reducing the extent of rod displacement caused by ageing of the aperture. It has moreover been found that the occurrence of optical coupling losses is reduced. Other uses include spectral analysis, such as IR and Raman spectrometry. The present optical system is in particular suitable for use in the field of telecommunications systems, solid-state lasers, spectral analysis systems and camera systems. In the case of camera systems, in particular the gradient index lens functionality is considered to be desirable.

The present invention further relates to a method for manufacturing an optical system comprising a substrate of glass and a polymeric replica layer disposed thereon, wherein a substrate, in which a functionality selected from the group consisting of grating, volume Bragg grating, holographic, diffractive, non-periodic structure, optical filter, polarizer, micro lens and gradient index lens is already implemented, is processed in such a manner that a substrate configured as a lens is obtained, whereupon the replica layer is replicated on the lens substrate thus obtained.

In addition to that, the present invention relates to a method for manufacturing an optical system, in which a surface layer of the substrate is processed so that a functionality is incorporated, which functionality is selected from the group consisting of grating, volume Bragg grating, holographic, diffractive, non-periodic structure, optical filter, polarizer, micro lens and gradient index lens, after which a polymeric layer is replicated on the thus processed surface layer, in such a manner that the replication layer thus obtained is configured as a lens.

The present optical system is in particular suitable for use in a stack of lenses, wherein a coating selected from the group of anti-reflection and infrared reflection is disposed between the polymeric replica layer and the substrate.

In a special embodiment it is possible to add a second spacer iv) to the aforesaid stack of lenses, on which second spacer iv) a second optical system according to the present invention is placed. Such a stack of lenses can thus be regarded as comprising, successively, an optically active or non-active element, a spacer, an optical system, a spacer and another optical system. It is moreover possible to extend such a stack of lenses with several optical systems, with or without the use of a spacer. The durable connection between the respective components of the stack of lenses is realised by means of an adhesive, in particular a thermosetting or a UV curable adhesive.

In a special embodiment, a film may be disposed between the spacer ii) and the optical system, said film having a function selected from the group consisting of diaphragm, anti-reflection, infrared reflection and aperture. The film is transparent in particular in the 370-700 nm wavelength range, said film being flexible and having a thickness of maximally 0.75 mm. The film is preferably provided with regularly spaced openings, wherein the positions of said openings correspond to the light path through the respective lens element and wherein the film does not transmit light in the operative range of 370-700 nm so as to prevent undesirable crosstalk between adjacent lens elements.

The present invention will now be explained in more detail with reference to a number of figures, in which connection it should be noted, however, that the present invention is by no means limited to such special embodiments.

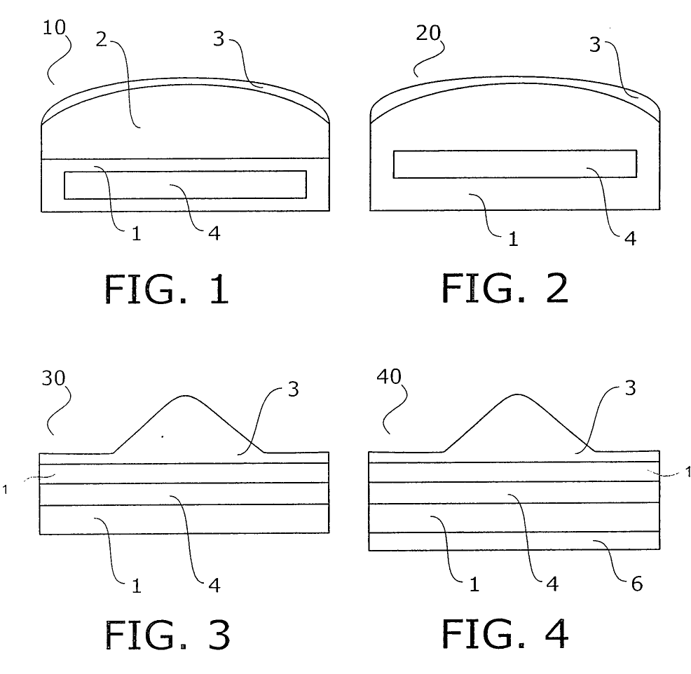

FIGS. 1-4 schematically show various embodiments of the present optical system.

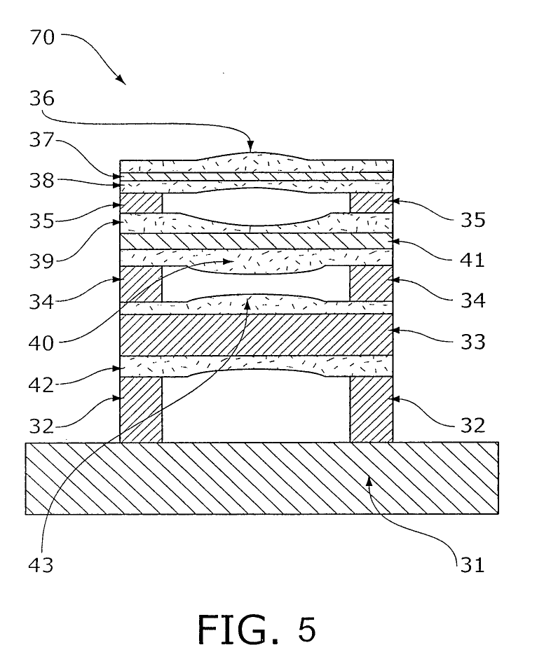

FIG. 5 shows a special embodiment of a stack of lenses.

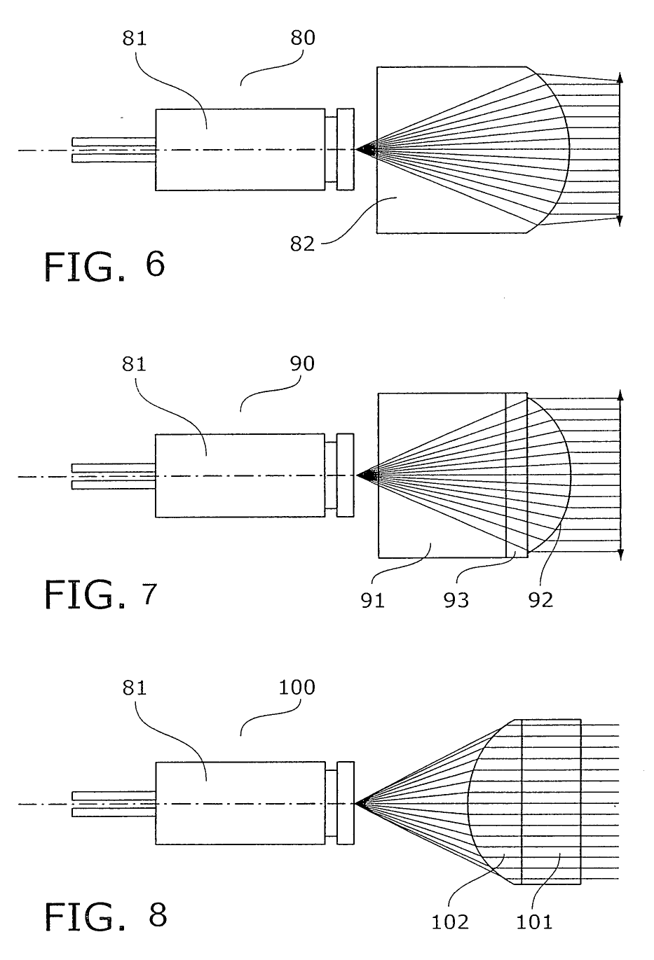

FIG. 6 shows a volume Bragg grating according to the prior art.

FIG. 7 shows a volume Bragg grating according to the present invention.

FIG. 8 shows a volume Bragg grating according to the present invention.

The numerals used in FIGS. 1-8 are consistently used to indicate like parts. FIG. 1 schematically shows an optical system 10 comprising a substrate 1 with a lens 2 disposed thereon, which lens 2 is provided with a polymeric replica layer 3. Incorporated in the substrate 1 is a functionality 4 selected from the group consisting of grating, volume Bragg grating, holographic, diffractive, non-periodic structure, optical filter, polarizer, micro lens and gradient index lens. In a specific embodiment, volume Bragg grating is preferred. According to another possibility, diffractive or polarizer or micro lens is preferred.

In FIG. 2, the substrate 1 for the optical system 20 is so configured that the substrate 1 has a lens function, whilst the lens structure of the substrate 1 is provided with a polymeric replica layer 3. A functionality 4 is incorporated in the substrate 1.

The function of replica layer in FIG. 1 and as well as in FIG. 2 can in particular be regarded as an optical correction for the substrate 1 configured as a lens, viz. an aspherical correction on a spherical lens, and/or a diffractive structure on top of the substrate 1. The object of the corrections is to correct optical errors, such as astigmatism, chromatic aberrations and depth of focus.

FIG. 3 shows a substrate 1 for an optical system 30, on which substrate 1 a polymeric replica layer 3 is disposed, which polymeric replica layer 3 is configured as a lens function. A functionality 4 is incorporated in the substrate 1.

The embodiment of the optical system 40 shown in FIG. 4 corresponds to that of FIG. 3, with this difference that FIG. 4 shows an optically active element 6, which extends over substantially the entire surface of the substrate 1.

FIG. 5 schematically shows a lens stack 70, in which an optically active or non-active element, such as a VCES (light source), a CMOS sensor 31, is provided with a spacer 32, on which spacer 32 a glass plate 33 is positioned, which glass plate 33 is provided with lens elements 43, 42 replicated on both sides thereof.

According to the present invention, a functionality selected from the group consisting of grating, volume Bragg grating, holographic, diffractive, non-periodic structure, optical filter, polarizer, micro lens and gradient index lens is incorporated in the glass plate 33, in which connection in particular gradient index lens is preferred for camera uses. The plate 33 has a lens element 42, 43 replicated thereon. By using the replication method, a durable connection between the plate 33 and a lens element 42, 43 has been realised and an integrated optical element has been formed. Thus, no air layers are present between the substrate, viz. the plate 33, and the lens elements 42, 43, and consequently no air layers are present between the functionality incorporated in the plate 33 and the lens elements 42, 43, either. Furthermore it has been found possible to incorporate a similar functionality in one or both replicated lens elements 43, 42. It is also possible to apply a coating, for example an anti-reflective or infrared reflective coating, between the lens elements 42, 43 and the glass plate 33.

In the illustrated embodiment, the spacer 34 is integrated in the lens element 43, which means that the lens element 43 and the spacer 34 form a uniform or inseparable whole. Furthermore, an embodiment is conceivable in which the spacer 34 is provided as a separate part, and in which the lens elements 40, the spacer 34 and the lens element 43 are thus durably joined together by means of an adhesive. According to yet another embodiment, the spacer 34 is integrated in the lens element 40, so that only one layer of adhesive is required for durably joining the glass plate 33 and the film 41 together. Using such integrated spacers it has been found possible to obtain more advantageous tolerance values for the stack height, because of the reduced number of adhesive layers and elements. Next, an assembly of lenses comprising a film 41 with a first and the second lens element 39, 40 replicated on both sides thereof is arranged on the spacer 34. Additionally, a spacer 35 is provided, on which spacer 35 another assembly of lenses comprising a film 37 is disposed, which film 37 is provided with lens elements 36, 38 replicated on both sides thereof. The mutual adhesion between the spacers 32 and 35, the glass plate 33 and the lens elements 42, 43, 40, 39, 38, 36 is effected by means of adhesives. Although it is indicated that the glass plate 33, which is provided with the lens elements 42, 43, is located closest to the optically active element 31, is also possible to use embodiments in which the film 41 provided with the lens elements 39, 40 is for example disposed on the spacer, followed by the glass plate 33 and finally the foil 37 provided with the lens elements 36, 38.

FIG. 6 schematically shows an optical system 80 that is known from the prior art, which comprises a laser source 81, wherein the light beam exiting the laser source 81 is passed through a volume Bragg grating 82 having a spherical lens shape, causing the light beam exiting the volume Bragg grating 82 to deviate slightly at the outer edges thereof.

FIG. 7 shows an optical system 90 according to the present invention, comprising a laser source 81 whose light beam exits into a volume Bragg grating element 91, on which a coating 93 is disposed, which coating is provided with a convex, aspherical lens 92 obtained by means of replication technology. Using the volume Bragg grating element 91, a coating 93 and the lens 92, a better laser cavity coupling is obtained than with the known optical system 80 shown in FIG. 6.

The optical system 100 that is schematically shown in FIG. 8 is substantially identical to the optical system 90 as shown in FIG. 7, with this difference that the light beam exiting the laser source 81 must first be coupled into a polymeric replica layer 102 configured as a lens, which replica layer 102 is directly provided on a volume Bragg grating element 101. The optical system 100 according to the present invention thus shows that control and collimation and distribution of the light before and after the volume Bragg grating can be realised in a simple manner.

1. An optical system comprising a substrate and disposed on said substrate a replica layer, characterized in that a functionality selected from the group consisting of grating, volume Bragg grating, holographic, diffractive, non-periodic structure, optical filter, polarizer, micro lens and gradient index lens is incorporated in the substrate.

2. An optical system according to claim 1, characterized in that the substrate is configured as a lens.

3. An optical system according to claim 1, characterized in that the replica layer is configured as a lens.

4. An optical system according to claim 1, characterized in that the optical system comprises, in succession, a substrate, a lens and a replica layer, whilst a functionality is incorporated in the substrate.

5. An optical system according to claim 1, characterized in that the substrate is composed of glass or a related optical, transparent inorganic material.

6. An optical system according to claim 1, characterized in that the replica layer is composed of a UV curable polymer.

7. An optical system according to claim 6, characterized in that said UV curable polymer has been selected from the group of polycarbonates, polystyrenes, poly(meth)acrylates, polyurethanes, polyamids, polyimids, polyethers, polyepoxides and polyesters.

8. An optical system according to claim 1, characterized in that the substrate is provided with an active or non-active optical element on the side remote from the replica layer.

9. An optical system according to claim 8, characterized in that said optical element has been selected from the group of light sources, such as VCSEL, laser diode, LED, RCLED, OLED and image sensors of the CCD/CMOS type.

10. An optical system according to claim 1, characterized in that a coating selected from the group consisting of anti-reflection and infrared reflection, is disposed between the replica layer and the substrate.

11. An optical system according to claim 1, characterized in that the functionality is of the volume Bragg grating type.

12. A method for manufacturing an optical system comprising a substrate of glass and a polymeric replica layer disposed thereon, characterized in that a substrate, in which a functionality selected from the group consisting of grating, volume Bragg grating, holographic, diffractive, non-periodic structure, optical filter, polarizer, micro lens and gradient index lens is already implemented, is processed in such a manner that a substrate configured as a lens is obtained, whereupon the replica layer is replicated on the lens substrate thus obtained.

13. A method for manufacturing an optical system comprising a glass substrate and a polymeric replica layer disposed thereon, characterized in that a surface layer of the substrate is processed so that a functionality is incorporated, which functionality is selected from the group consisting of grating, volume Bragg grating, holographic, diffractive, non-periodic structure, optical filter, polarizer, micro lens and gradient index lens, after which a polymeric layer is replicated on the thus processed surface layer, in such a manner that the replication layer thus obtained is configured as a lens.

14. A method for manufacturing an optical system according to claim 12, characterized in that the substrate is provided with a coating selected from the group of anti-reflection and infrared reflection, after which the polymeric layer is replicated onto the coating thus applied.

15. Use of an optical system according to claim 1 in telecommunication systems.

16. Use of an optical system according to claim 1 in solid-state lasers.

17. Use of an optical system according to claim 1 in spectral analysis systems.

18. Use of an optical system according to claim 1 in camera systems.

19. A stack of lenses, comprising an optically active or non-active element, one or more spacer substrates and lens elements placed thereon, said stack comprising, in succession:
i) an optically active or non-active element,
ii) a spacer, and
iii) an optical system according to claim 1, which extends over substantially the entire surface of said optically active or non-active element.

20. A stack of lenses according to claim 19, characterized in that a second spacer iv) is disposed on the optical system iii), on the side remote from said optically active or non-active element i), on which second spacer an optical system according to one or more of claims 1-11 is placed, which optical system extends over substantially the entire surface of said optically active or non-active element.

21. A stack of lenses according to claim 19, characterized in that a film is disposed between said spacer ii) and said optical system iii).

22. A stack of lenses according to claim 21, characterized in that said film has a function selected from the group consisting of diaphragm, anti-reflection, infrared reflection and aperture.

23. A stack of lenses according to claim 21, characterized in that said film is transparent in the 370-700 nm wavelength range.

24. A stack of lenses according to claim 21, characterized in that said film is flexible and has a thickness of maximally 0.75 mm.

25. A stack of lenses according to claim 21, characterized in that the film is provided with regularly spaced openings, the positions of which openings correspond to the light path through the respective lens element.

26. A stack of lenses according to claim 25, characterized in that the film does not transmit light in the operative range of 370-700 nm so as to prevent undesirable crosstalk between adjacent lens elements.
